(19) United States
(12) Patent Application Publication
(10) Pub. No.: US 2011/0274896 A1
(43) Pub. Date: Nov. 10, 2011

(54) CHROMOPHORIC OR EFFECT-GENERATING MULTILAYER PAINT COATINGS HAVING PIGMENT-FREE COATS OF PAINT AS FILLER SUBSTITUTE, THE PRODUCTION THEREOF AND USE THEREOF

(75) Inventors: Jörg Krames, Lauf (DE); Hitoshi Taniguchi, Yokohama (JP); Egon Wegner, Greven (DE); Michael Richert, Emsdetten (DE)

(73) Assignees: BASF COATINGS GMBH, Munster (DE); BASF COATINGS JAPAN LTD., Yokohama (JP)

(21) Appl. No.: 13/127,330

(22) PCT Filed: Nov. 2, 2009
(86) PCT No.: PCT/EP2009/007832

§ 371 Date: Jul. 26, 2011

(30) Foreign Application Priority Data
Nov. 3, 2008 (DE) 10 2008 054 283.0

(51) Int. Cl. B32B 3/00; B05D 1/04; B05D 5/00; B05D 3/00; B05D 5/06; B05D 1/36; B05D 1/02

(52) U.S. Cl. 428/203; 427/331; 427/470

(57) ABSTRACT

Multicoat color and/or effect finishes on substrates, comprising, lying atop one another in this order:
(A) at least one pigment-free coating,
(B) at least one color and/or effect coating, and
(C) at least one transparent coating,
   processes for producing them, and their use.

The present invention relates to multicoat color and/or effect finishes and substrates. The invention further relates to a process for producing them and also to their use.

The requirements imposed on finishes are broad: for example, they are to fulfill a protective or decorative function. In the automobile segment, for instance, finishes are to have chemical and physical resistance. The decorative aspects are provided by attractive colors and by smooth and glossy surfaces. Finishes are also to be user-friendly, i.e., require low maintenance.

The optimum surface optical qualities (“appearance”) are a key requirement imposed on the coating outcome. These qualities include, for example, gloss, fullness, absence of haze, and uniformity and constancy in terms of shade and effect (cf. Ulrich Zorll (ed.): Lehrbuch der Lacktechnologie, 2nd edition 2000, Vincentz Verlag, Hanover, ISBN 3-87870-569-7, pages 326-327).

The skilled worker knows of diverse possibilities for generating good appearance in a finish. An OEM vehicle finish, for example, is typically constructed by applying a primer-surfacer to a corrosion control coat, said primer-surfacer affording functions which include stone-chip protection and UV resistance. Moreover, it assists the perception of the shade and the appearance. Applied over this system is a basecoat, responsible for shade and appearance, and subsequently a clearcoat. The clearcoat serves to maintain and enhance the resistance properties and the appearance.

Patent application US 2003/0059617 A1, for example, describes a multicoat finish comprising three coats which is applied to an electrodeposition coating. The coating there comprises a primer-surfacer (“primer”), a basecoat, and a clearcoat film. The coating is applied in a “3 coat 1 bake” process. The primer there contains at least 10% of pigment, based on the total weight of pigment and resin solids. Lowering the pigment content results in poor appearance of the coating.

DE 102004028368 A1 discloses a process for producing a multicoat finish. The multicoat finish is constructed on, optionally, a primer (an electrodeposition coat, for example), a first color and/or effect basecoat, a second color and/or effect basecoat, and a clearcoat. The typical primer-surfacer coat is replaced by a basecoat which comprises at least one color and/or effect pigment, at least one pigment that absorbs UV radiation, and talc.

To enhance the appearance of a surface, for example, the clearcoat film is applied twice. That necessitates a second application and a second drying. Alternatively the film thickness of the clearcoat is increased, but leads to runs or cratering such as pops, for example.

It was an object of the present invention to eliminate the above-described drawbacks of the prior art. The intention was to provide multicoat color and/or effect finishes which maintain good stone-chip and UV resistance but have an improved appearance, especially on substrates with poor surface qualities such as rough surfaces. It was further intended that the multicoat finishes should take account of economic aspects, the new multicoat finishes allowing cost savings to be achieved in comparison to prior-art finishes, while at the same time featuring enhanced appearance.

Found, surprisingly, have been multicoat finishes of the type specified at the outset that have allowed the appearance of a coating surface to be improved. Found, accordingly, have been multicoat color and/or effect finishes on substrates, comprising, lying atop one another in this order,
(A) at least one pigment-free coating,
(B) at least one color and/or effect coating, and
(C) at least one transparent coating.

In this system the coating (A) replaces the primer-surfacer coating.

Particularly surprising in this context is the fact that improving the appearance, in contrast to the opinion in the prior art, could be achieved by means of a primer-surfacer substitute coat that contains no pigments. Key properties of a multicoat finish, such as the stone-chip protection, for example, are retained. Also, surprisingly, it was possible to improve the appearance even in the case of substrates having a comparatively rough surface.

Roughness provides a summary characterization of the surface form of a coating film or of a substrate. It can be determined quantitatively by reference to a comparative norm or to a roughness dimension (see Ulrich Zorll (ed.): Römpp Lexikon Lacke und Druckfarben, 1998, Georg Thieme Verlag, Stuttgart, ISBN 3-13-776001-1; entry heading “Rauhigkeit”).

The pigment-free coatings (A), accordingly, contain no pigments. Pigments are colorants in powder or platelet form which, in contrast to dyes, are insoluble in the surrounding medium (cf. Ulrich Zorll (ed.): Rompp Lexikon Lacke und Druckfarben, 1998, Georg Thieme Verlag, Stuttgart, ISBN 3-13-776001-1; entry headings “Pigmente”, “Farbmittel”, “Farbstoffe”). Pigments for the purposes of this invention comprehend not only color and/or effect pigments but also functional pigments such as anticorrosion pigments, stone-chip protection pigments, and UV absorption pigments.

The transparent coating (A) is obtained from a transparent, in particular optically clear coating material (A′) curable thermally and/or with actinic radiation, more particularly from a clearcoat material.

By actinic radiation is meant electromagnetic radiation, such as near infrared (NIR), visible light, UV radiation, X-rays, and gamma radiation, especially UV radiation, and particulate radiation, such as electron beams, beta radiation, proton beams, neutron beams, and alpha radiation, especially electron beams.

Suitable clearcoat materials of coating material (A′) include all typical and known one-component (1K), two-component (2K) or multicomponent (3K, 4K) clearcoat, powder clearcoat, powder slurry clearcoat or UV-curable clearcoat materials.

Thermally curable one-component (1K), two-component (2K) or multicomponent (3K, 4K) clearcoat materials are known, for example, from patent applications DE 42 04 518 A1, EP 0 594 068 A1, EP 0 594 071 A1, EP 0 594 142 A1, EP 0 604 992 A1 or EP 0 596 460 A1, international patent applications WO 94/10211, WO 94/10212, WO 94/10213, WO 94/22969 or WO 92/22615, or American patents U.S. Pat. No. 5,474,811 A, U.S. Pat. No. 5,356,669 A or U.S. Pat. No. 5,605,965 A.

One-component (1K) clearcoat materials comprise, as is known, hydroxyl-containing binders and crosslinking agents such as blocked polyisocyanates, tris(alkoxycarbonylamino)triazines and/or amino resins. In a further variant they comprise polymers with pendant carbamate and/or allophanate groups as binders, and carbamate- and/or allophanate-modified amino resins as crosslinking agents (cf.

American patents U.S. Pat. No. 5,474,811 A, U.S. Pat. No. 5,356,669 A or U.S. Pat. No. 5,605,965 A1, international patent applications WO 94/10211, WO 94/10212 or WO 94/10213 or European patent applications EP 0 594 068 A1, EP 0 594 071 A1 or EP 0 594 142 A1.

Two-component (2K) or multicomponent (3K, 4K) clearcoat materials comprise as essential constituents, as is known, hydroxyl-containing binders and polyisocyanates as crosslinking agents, these constituents being stored separately prior to their use.

Thermally curable powder clearcoat materials are known, for example, from German patent application DE 42 22 194 A1, the BASF Lacke+Farben AG product information material “Pulverlacke”, 1990, or the BASF Coatings AG publication “Pulverlacke, Pulverlacke fur industrielle Anwendungen”, January 2000. Powder clearcoat materials comprise as essential constituents, as is known, binders containing epoxide groups, and polycarboxylic acids as crosslinking agents.

Examples of suitable powder slurry clearcoat materials are known from US patent U.S. Pat. No. 4,268,542 A1 and patent applications DE 195 40 977 A1, DE 195 18 392 A1, DE 196 17 086 A1, DE 196 13 547 A1, EP 0 652 264 A1, DE 196 18 657 A1, DE 196 52 813 A1, DE 196 17 086 A 1 or DE 198 14 471 A1. Powder slurry clearcoat materials comprise, as is known, powder clearcoat materials in dispersion in an aqueous medium.

Clearcoat, powder clearcoat, and powder slurry clearcoat materials that are curable with actinic radiation are disclosed in, for example, European patent applications EP 0 928 800 A1, EP 0 636 669 A1, EP 0 410 242 A1, EP 0 783 534 A1, EP 0 650 978 A1, EP 0 650 979 A1, EP 0 650 985 A1, EP 0 540 884 A1, EP 0 568 967 A1, EP 0 054 505 A1 or EP 0 002 866 A1, German patent applications DE 199 17 965 A1, DE 198 35 206 A1, DE 197 09 467 A1, DE 42 03 278 A1, DE 33 16 593 A1, DE 38 36 370 A1, DE 24 36 186 A1 or DE 20 03 579 B1, international patent applications WO 97/46549 or WO 99/14254, or American patents U.S. Pat. No. 5,824,373 A, U.S. Pat. No. 4,675,234 A, U.S. Pat. No. 4,634,602 A, U.S. Pat. No. 4,424,252 A, U.S. Pat. No. 4,208,313 A, U.S. Pat. No. 4,163,810 A, U.S. Pat. No. 4,129,488 A, U.S. Pat. No. 4,064,161 A or U.S. Pat. No. 3,974,303 A.

Clearcoat, powder clearcoat, and powder slurry clearcoat materials that are curable thermally and with actinic radiation are disclosed in, for example, patent applications DE 198 18 735 A1, WO 98/40170, DE 199 08 013 A1, DE 199 08 018 A1, EP 0 844 286 A1 or EP 0 928 800 A1.

It is preferred to use thermally curable clearcoat materials, or clearcoat materials curable thermally and with actinic radiation, as coating materials (A′). Coating material (A′) is preferably an aqueous coating material.

The color and/or effect coating (B) is obtained from a color and/or effect coating material (B′) curable thermally and/or with actinic radiation, in particular from a basecoat material.

Coating material (B′) is preferably an aqueous coating material.

Coating material (B′) comprises at least one color and/or effect pigment. Preferably the pigment is selected from the group consisting of organic and inorganic, color-imparting, optical effect-imparting, color- and optical effect-imparting, fluorescent and phosphorescent pigments, especially from the group consisting of organic and inorganic, color-imparting, optical effect-imparting, and color- and optical effect-imparting pigments.

Examples of suitable effect pigments, which may also impart color, are metal plate pigments, such as commercial aluminum bronzes, aluminum bronzes chromated in accordance with DE 36 36 183 A1, and commercial stainless-steel bronzes, and also nonmetallic effect pigments, such as pearlescent pigments and interference pigments, platelet-shaped effect pigments based on iron oxide with a shade of from pink to brownish red, or liquid-crystalline effect pigments, for example. For further details, refer to Römpp Lexikon Lacke und Druckfarben, Georg Thieme Verlag, 1998, page 176, “Effect pigments” and pages 380 and 381 “Metal oxide/mica pigments” to “metal pigments”, and to patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A.

Examples of suitable inorganic color pigments are white pigments such as zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details refer to Rompp Lexikon Lacke und Druckfarben, entry headings pages 180 and 181, “iron blue pigments” to “black iron oxide”, pages 451 to 453 “pigments” to “pigment volume concentration”, page 563 “thioindigo pigments”, page 567 “titanium dioxide pigments”, pages 400 and 467, “naturally occurring pigments”, page 459 “polycyclic pigments”, page 52, “azomethine pigments”, “azo pigments” and page 379, “metal complex pigments”.

Examples of fluorescent and phosphorescent pigments (daylight-fluorescent pigments) are bis(azomethine) pigments.

Coating material (B′) may further comprise functional pigments such as magnetically shielding, electrically conductive, corrosion-inhibiting, UV radiation-absorbing or stone-chip protection pigments.

Examples of magnetically shielding pigments are pigments based on iron oxides or chromium dioxide. Examples of suitable electrically conductive pigments are titanium dioxide/tin oxide pigments. Examples of suitable corrosion-inhibiting pigments are lead silicates, zinc phosphates or zinc borates. An example of a suitable stone-chip protection pigment is talc.

The UV radiation-absorbing pigments are preferably selected from the group consisting of titanium dioxide pigments and carbon black pigments. It is preferred to use at least one titanium dioxide pigment and at least one carbon black pigment.

The amount of functional pigments in (B′) may vary very widely and is guided by the requirements of the case in hand. Preferably the amount of functional pigment in (B′), based on the solids of (B′), is 0.001% to 6%, more preferably 0.01% to 5%, in particular 0.01% to 4%, by weight.

The amount of pigments in coating material (B′) may vary very widely and is guided primarily by the intensity of the effects, especially the optical effects, and/or by the shade which is or are to be established.

The coating (C) is obtained from a transparent, especially optically clear coating material (C′) curable thermally and/or with actinic radiation, especially a clearcoat material.

Suitable clearcoat materials of coating material (C′) include all clearcoat materials also coming into consideration as coating materials (A′). Coating material (C′) may be the same as or different than coating material (A′).

Coating materials (C′) may comprise functional, effect and/or transparent, colored pigments. Coating material (C′) advantageously comprises at least one functional pigment. Functional pigments allow improvements in properties of the multicoat finish, such as UV resistance and stone-chip protection.

The substrates to which the multicoat finish of the invention is applied may be composed of any of a very wide variety of materials and combinations of materials. Preferably they are composed of metals, plastics, glass, wood, leather, textile, ceramic or natural stone, more preferably of metals, plastics, and glass, especially of metals and plastics.

The multicoat finish of the invention is especially advantageous on substrates with a rough surface.

The intended uses of the substrates may be any from a wide variety. The substrates are preferably bodies of means of transport, including watercraft, rail vehicles, aircraft, vehicles operated with muscle power, and motor vehicles, especially automobiles, motor bikes, trucks, and buses, and parts thereof; buildings and parts thereof; doors, windows; furniture; small industrial parts; mechanical, optical, and electronic components; coils, containers; packaging, hollow glassware, and articles of everyday use.

The substrates are preferably bodies of motor vehicles and parts thereof. Particular preference is given to automobiles and parts thereof. The bodies are preferably provided with a primer (G). Where the bodies are of steel, typical and known electrodeposition coats are used as primers (G). The electrodeposition coats (G) are produced in typical and known fashion from electrocoat materials which can be deposited electrophoretically, especially cathodically. The resulting electrocoat films (G) can be cured thermally before the aqueous coating material (A′) is applied.

Alternatively they can be merely dried without curing, or with only partial curing, after which they are cured jointly with the other films (A), (B), and (C).

Where the bodes are of aluminum, aluminum oxide layers generated by anodic oxidation are used as primers (G), and as such require no further curing. Where parts of the bodies, i.e., those referred to as mounted components, are composed of plastics, they are preferably provided with a typical and known water-based primer (G), or the adhesion properties of their surface are improved by means of chemical and/or physical methods. In these cases as well it is generally unnecessary to cure the primers (G).

The invention further provides a process for producing the multicoat finishes of the invention on substrates. Coatings (A), (B), and (C) are obtained by successive application of at least one coating material (A′), at least one coating material (B′), and at least one further coating material (C′) to
(i) an unprimed substrate,
(ii) a substrate coated with at least one uncured or only partially cured primer (G) or
(iii) a substrate coated with at least one fully cured primer (G)
   and joint curing of
(1) the resulting wet films of the coating materials (A′), (B′), and (C′) or
(2) (A′), (B′), and (C′) and the uncured or only partially cured primer or primers (G).

Coating materials (A′), (B′), and (C′) can be applied using all of the typical and known methods of applying liquid coating materials. For the process of the invention, however, it is of advantage if they are applied by means of pneumatic spray application or of electrostatic spray application (ESTA), preferably with high-speed rotary bells.

In the process of the invention the applied films (A), (B), and (C) are jointly cured thermally. Where coating material (A′) is also curable with actinic radiation, an aftercure takes place by exposure to actinic radiation. Where any primer (G) used has not yet been cured, it is cured as well in this process step.

Curing may take place after a certain rest time. This time may have a duration of 30 seconds to 2 hours, preferably 1 minute to 1 hour, and in particular 1 to 45 minutes. The rest time serves, for example, for the leveling and degassing of the coating films or for the evaporation of volatile constituents. The rest time may be assisted and/or shortened by the application of elevated temperatures of up to 90° C. and/or by a reduced air humidity <10 g water/kg air, in particular <5 g/kg air, provided this is not accompanied by any instances of damage to or change in the coating films, such as premature complete crosslinking, for instance.

The thermal cure has no peculiarities of method but instead takes place in accordance with typical and known methods such as heating in a forced-air oven or irradiation with IR lamps. The thermal cure may also be accomplished in stages. A further preferred curing method is that of curing with near infrared (NIR radiation). Particular preference is given to employing a process in which the water constituent is removed rapidly from the wet films. Suitable such processes are described, for example, by Rodger Talbert in Industrial Paint & Powder, 04/01, pages 30 to 33, “Curing in Seconds with NIR”, in Galvanotechnik, volume 90 (11), pages 3098 to 3100, or “Lackiertechnik, NIR-Trocknung im Sekundentakt von Flüssig- and Pulverlacken”.

The thermal cure takes place advantageously at a temperature of 50 to 170, more preferably 60 to 165, and in particular 80 to 150° C., over a time of 1 minute to 2 hours, more preferably 2 minutes to 1 hour, and in particular 3 to 30 minutes. The thermal cure may be supplemented by the cure with actinic radiation, in particular with UV radiation. In these cases it is possible to employ the typical and known methods and apparatus as described in, for example, German patent application DE 199 20 799 A1, page 11, lines 5 to 21.

The present invention further provides for the use of the multicoat finish to coat substrates. The multicoat finish of the invention preferably finds use in the OEM finishing of motor vehicle bodies and parts thereof, preferably for automobiles, especially top-class automobiles.

The invention is elucidated further below with reference to examples.

### EXAMPLES

### 1) Preparation of an Aqueous Transparent Sealer

18.0 parts of a paste of a synthetic sodium aluminum silicate with a layer structure, as a 3% paste in water (thickener, from Laporte), are introduced and mixed, with stirring, in succession with 25.0 parts of a polyurethane dispersion (polyurethane dispersion B of EP-P-787159, page 15 line 20 to page 16 line 2) and 3.0 parts of a polyester resin solution (polyester resin solution A of EP-P-787159, page 15 lines 1 to 17), 3.3 parts of butyl glycol, 4.8 parts of a commercial melamine resin (Cymel 327 from Cytec Industries), 0.3 part of a neutralizing solution (dimethylethanolamine, 10% by weight in water), 4.0 parts of a polyurethane-modified polyacrylate (polyacrylate D of EP-P-787159, page 16 line 30 to page 17 line 38), 2.7 parts of isopropanol, 2.4 parts of ethylhexanol, 6.0 parts of deionized water, 1.2 parts of a mixture (ratio 1:1) of Nopco DSX 1550 (polyurethane thickener, from Henkel) and butyl glycol, and 6.3 parts of deionized water.

### 2) Test System and Test Results

To test the topcoat holdout, the aqueous transparent sealer (see preparation instructions) was applied with a film thickness of 15 μm to test panels and subjected to initial drying at 80° C. for 10 minutes. The test panels are composed of steel substrates (bodywork sheet) which had been coated with two typical and known, cathodically deposited and baked electrodeposition coats (CG500 and CG320, film thickness each 20 μm).

After coating with cathodic electrodeposition coats, the test panels were measured using a Perthometer to determine the roughness (RA values).

Thereafter the panels were coated with a commercial, silver metallic aqueous basecoat material (Colorbright from BASF Coatings), subjected to initial drying at 80° C. for 10 minutes, cooled, and coated with a commercial two-component polyurethane clearcoat material (EVERGLOSS®, BASF Coatings, film thickness 40 μm). After that, the aqueous basecoat film and clearcoat film obtained were baked at 130° C. for 30 minutes.

The standard system (comparative) was the same system but with the transparent film replaced by a coating of a commercial water-based primer-surfacer (STARBLOC®, dried at 150° C. for 20 minutes, film thickness 25-30 μm).

The test panels produced in this way had their topcoat holdout characterized by determination of the longwave and shortwave values using the Byk-Gardner wave.-scan DOI instrument. The smaller the values, the better the topcoat holdout.

| | CG320 | CG500 |
|---|---|---|
| | (RA value = 0.62) | (RA value = 0.30) |
| STARBLOC (comparative) | | |
| Longwave vertical | 14.1 | 13.0 |
| Longwave horizontal | 5.0 | 4.3 |
| Shortwave vertical | 19.0 | 13.0 |
| Shortwave horizontal | 20.0 | 14.0 |
| Transparent sealer | | |
| (inventive) | | |
| Longwave vertical | 10.0 | 9.0 |
| Longwave horizontal | 3.0 | 2.5 |
| Shortwave vertical | 11.0 | 10.5 |
| Shortwave horizontal | 10.0 | 10.4 |

Despite the difference in the roughnesses of CG320 and CG500, the transparent film of the invention showed no differences in the longwave and shortwave values at different roughnesses. The standard system, in the comparative experiment, in contrast, showed poorer longwave and shortwave values for poorer roughnesses (CG320).

1. A multicoat color and/or effect finish on a substrate, comprising:
(A) at least one pigment-free coating,
(B) at least one color and/or effect coating lying atop the at least one pigment-free coating (A), and
(C) at least one transparent coating lying atop the at least one color and/or effect coating (B).

2. The multicoat finish of claim 1, wherein coating (A) is produced from a transparent coating material (A′) curable thermally and/or with actinic radiation.

3. The multicoat finish of claim 2, wherein the coating material (A′) is a clearco at material.

4. The multicoat finish of claim 2, wherein the coating material (A′) is an aqueous coating material.

5. The multicoat finish of claim 1, wherein coating (B) is produced from a transparent coating material (B′) curable thermally and/or with actinic radiation.

6. The multicoat finish of claim 5, wherein the coating material (B′) is a basecoat material.

7. The multicoat finish in claim 5, wherein the coating material (B′) is an aqueous coating material.

8. The multicoat finish of claim 5, wherein the coating material (B′) comprises a color and/or effect pigment.

9. The multicoat finish of claim 5, wherein the coating material (B′) comprises a functional pigment.

10. The multicoat of claim 1, wherein coating (C) is produced from a transparent coating material (C′) curable thermally and/or with actinic radiation.

11. The multicoat finish of claim 1, wherein the substrate comprises at least one material selected from the group consisting of metals, plastics, glass, wood, leather, textile, ceramic or natural stone.

12. A process for producing the multicoat color and/or effect finish of claim 1 comprising,
applying to a substrate at least one coating material (A′) to produce a wet film of the coating material (A′);
subsequently applying at least one coating material (B′) to the wet film of the coating material (A′) to produce a wet film of the coating material (B′),
subsequently applying at least one further coating material (C′) to the wet film of the coating material (B′) to produce a wet film of the coating material (C′),
wherein the substrate is at least one of
(i) an unprimed substrate,
(ii) a substrate coated with at least one uncured or only partially cured primer (G) and
(iii) a substrate coated with at least one fully cured primer (G) and
jointly curing of
(1) the resulting wet films of the coating materials (A′), (B′), and (C′) or
(2) the resulting wet films of the coating materials (A′), (B′), and (C′) and the uncured or only partially cured primer or primers (G).

13. The process of claim 12, wherein the coating materials (A′), (B′), and (C′) are applied by means of pneumatic spray application or by electrostatic spray application (ESTA).

14. A substrate coated with the multicoat finish claim 1.

15. The process of claim 13, wherein the coating materials (A′), (B′), and (C′) are applied with high speed rotary bells.
